(19) United States
(12) Patent Application Publication
(10) Pub. No.: US 2014/0371366 A1
(43) Pub. Date: Dec. 18, 2014

(54) Flame Retardant Polyester Composition

(71) Applicant: SABIC Innovative Plastics IP B.V., BERGEN OP ZOOM (NL)

(72) Inventors: Zhenke Wei, Shanghai (CN); Hongtao Shi, Shanghai (CN); Ying Xi, Shanghai (CN); Dake Shen, Shanghai (CN); Yeyang Lin, Shanghai (CN)

(21) Appl. No.: 13/917,771

(22) Filed: Jun. 14, 2013

(51) Int. Cl. C08L 67/02

(52) U.S. Cl. CPC C08L 67/02
USPC 524/409

(57) ABSTRACT

Disclosed herein is a method of reducing the amount of antimony flame retardant compound in a flame retardant composition which comprises using a combination of an alkali metal carbonate with a brominated flame retardant compound in the composition, wherein the composition comprises: (a) a polyester; (b) a brominated flame retardant compound; (c) an antimony flame retardant compound; (d) an alkali metal carbonate; and optionally (e) glass fiber.

Also disclosed are compositions prepared by such a method and articles derived therefrom.

### BACKGROUND OF THE INVENTION

Polyesters, particularly polybutylene terephthalate (PBT) and polyethylene terephthalate (PET), are widely used as components in various flame retardant plastics to cover electrical wires and electrical components. Many of the flame retardant polyester compositions currently available contain a brominated flame retardant compound as well as an antimony flame retardant compound which is frequently antimony trioxide (Sb₂O₃). However, such compositions have some drawbacks. For instance, using brominated components and Sb₂O₃ in the flame retardant compositions can reduce the comparative tracking index (CTI) of polyesters such as PBT, especially when brominated polycarbonate or tetrabromobisphenol-A carbonate oligomers are also present. CTI measures the electrical breakdown (tracking) of insulating materials. A reduction in CTI indicates lower insulating performance. In addition, because of their acidity, brominated components and Sb₂O₃ cause compositions to age at a faster rate than compositions that don't contain brominated components and antimony oxide. Finally, the use of Sb₂O₃ presents a significant health risk to consumers.

As a result, there is an ongoing need for alternative, less-costly flame retardant polyester compositions that contain minimized amounts of antimony flame retardant compound, but that maintain or surpass the performance attributes of currently available flame retardant polyester compositions.

### SUMMARY OF THE INVENTION

These and other needs are met by the present invention which is directed to a method for reducing the amount of antimony flame retardant compound that is needed in a flame retardant composition, as well as compositions prepared according to the method. By using a combination of an alkali metal carbonate with a brominated flame retardant compound, the amount of antimony flame retardant compound that is used in the polyester compositions can be reduced by as much as 50 percent. The resulting compositions have comparable or improved performance characteristics and pose less of a health risk to consumers. The compositions also provide a significant cost savings, since alkali metal carbonates are cheaper to use as additives than antimony trioxide.

Thus, in one aspect, the invention provides a method of reducing the amount of antimony flame retardant compound in a flame retardant composition which comprises using a combination of an alkali metal carbonate with a brominated flame retardant compound in the composition, wherein the composition comprises:
(a) 30 to 80 percent by weight of a polyester;
(b) 3 to 30 percent by weight of a brominated flame retardant compound;
(c) 0.1 to 5 percent by weight of an antimony flame retardant compound;
(d) 0.03 to 0.9 percent by weight of an alkali metal carbonate; and
(e) 0 to 50 percent by weight of glass fiber; and wherein:
   (i) the composition meets or exceeds the requirements of UL94-V2;
   (ii) less antimony retardant compound is present in the composition comprising (a), (b), (c), and (d) as compared to a composition comprising component (a), (b), (c) and no (d);
   (iii) the comparative tracking index (CTI) for a composition comprising (a), (b), (c), and (d) is the same as or greater than the CTI of a composition comprising component (a), (b), (c) and no (d);
   (iv) the composition does not contain a phosphorous containing flame retardant;
   and wherein the percent by weights are based on the total weight of the composition.

The invention also provides compositions prepared according to the method as well as articles derived therefrom.

### DETAILED DESCRIPTION OF THE INVENTION

If a term in the present application contradicts or conflicts with a term in a reference, the term in the present application takes precedence over the conflicting term from the reference. All ranges disclosed herein are inclusive of the endpoints, and the endpoints are independently combinable with each other. The use of the terms “a” and “an” and “the” and similar referents in the context of describing the invention (especially in the context of claims) are to be construed to cover both the singular and the plural, unless otherwise indicated herein or clearly contradicted by context. It should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (that is, it includes the degree of error associated with measurement of the particular quantity). As used herein all percent by weights are based on the total weight of the composition.

As provided in the Summary, the compositions of the invention do not contain a phosphorous containing flame retardant. For the purposes of this application, “phosphorous containing flame retardant (FR)” means a flame retardant containing phosphorous such as melamine phosphate (CAS No. 20208-95-1), melamine pyrophosphate (MPP) (CAS No. 15541-60-3), melamine polyphosphate (CAS No. 218768-84-4), polyphosphazine, boron phosphate (CAS No. 13308-51-5), red phosphorous (CAS No. 7723-14-0), organophosphate esters, monoammonium phosphate (CAS No. 7722-76-1), diammonium phosphate (CAS No. 7783-28-0), alkyl phosphonates, metal dialkyl phosphinate, ammonium polyphosphates. Organophosphate ester FRs include phosphate esters comprising phenyl groups, substituted phenyl groups, or a combination of phenyl groups and substituted phenyl groups, bis-aryl phosphate esters based upon resorcinol such as, for example, resorcinol bis-diphenylphosphate, as well as those based upon bis-phenols such as, for example, bis-phenol A bis-diphenylphosphate (BPADP). More specifically organophosphate esters include tris(alkylphenyl) phosphate (for example, CAS Reg. No. 89492-23-9 or CAS Reg. No. 78-33-1), resorcinol bis-diphenylphosphate (for example, CAS Reg. No. 57583-54-7), bis-phenol A bis-diphenylphosphate (for example, CAS Reg. No. 181028-79-5), triphenyl phosphate (for example, CAS Reg. No. 115-86-6), tris(isopropylphenyl) phosphate (for example, CAS Reg. No. 68937-41-7), triphenyl phosphate (CAS Reg. No. 115-86-6), and phosphoric acid, P,P′-1,3-phenylene P,P,P′,P′-tetrakis(2,6-dimethylphenyl) ester (CAS Reg. No. 139189-30-3).

### Polyester

The composition comprises a polyester of formula 1:

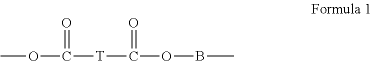

wherein:

B is a divalent radical derived from a dihydroxy compound, and may be, for example, a C₂₋₁₀ alkylene radical, a C₆₋₂₀ alicyclic radical, a C₆₋₂₀ aromatic radical or a polyoxyalkylene radical in which the alkylene groups contain 2 to 6 carbon atoms, specifically 2, 3, or 4 carbon atoms; and

T is a divalent radical derived from a dicarboxylic acid, and may be, for example, a C₂₋₁₀ alkylene radical, a C₆₋₂₀ alicyclic radical, a C₆₋₂₀ alkyl aromatic radical, or a C₆₋₂₀ aromatic radical.

Various polyesters can be used in this invention, but thermoplastic polyesters that are obtained by polymerizing dicarboxylic acids and dihydroxy compounds are particularly preferred.

Aromatic dicarboxylic acids, for example, terephthalic acid, isophthalic acid, naphthalene dicarboxylic acid and the like, can be used as these bifunctional carboxylic acids, and mixtures of these can be used as needed. Among these, terephthalic acid is particularly preferred. Also, to the extent that the effects of this invention are not lost, other bifunctional carboxylic acids such as aliphatic dicarboxylic acids can be used, such as oxalic acid, malonic acid, adipic acid, suberic acid, azelaic acid, sebacic acid, decane dicarboxylic acid, and cyclohexane dicarboxylic acid; and their ester-modified derivatives can also be used.

As dihydroxy compounds, straight chain aliphatic and cycloaliphatic diols having 2 to 15 carbon atoms can be used; for example, ethylene glycol, propylene glycol, 1,4-butanediol, trimethylene glycol, tetramethylene glycol, neopentyl glycol, diethylene glycol, cyclohexane dimethanol, heptane-1,7-diol, octane-1,8-diol, neopentyl glycol, decane-1,10-diol, etc.; polyethylene glycol; bivalent phenols such as dihydroxydiarylalkanes such as 2,2-bis(4-hydroxylphenyl)propane that can be called bisphenol-A, bis(4-hydroxyphenyl) methane, bis(4-hydroxyphenyl)naphthylmethane, bis(4-hydroxyphenyl)phenylmethane, bis(4-hydroxyphenyl)-(4-isopropylphenyl)methane, bis(3,5-dichloro-4-hydroxyphenyl)methane, bis(3,5-dimethyl-4-hydroxyphenyl)methane, 1,1-bis(4-hydroxyphenyl)ethane, 1-naphthyl-1,1-bis(4-hydroxyphenyl)ethane, 1-phenyl-1,1-bis(4-hydroxyphenyl)ethane, 1,2-bis(4-hydroxyphenyl)ethane, 2-methyl-1,1-bis(4-hydroxyphenyl)propane, 2,2-bis(3,5-dimethyl-4-hydroxyphenyl)propane, 1-ethyl-1,1-bis(4-hydroxyphenyl)propane, 2,2-bis(3,5-dichloro-4-hydroxyphenyl)propane, 2,2-bis(3,5-dibromo-4-hydroxyphenyl)propane, 2,2-bis(3-chloro-4-hydroxyphenyl)propane, 2,2-bis(3-methyl-4-hydroxyphenyl)propane, 2,2-bis(3-fluoro-4-hydroxyphenyl)propane, 1,1-bis(4-hydroxyphenyl)butane, 2,2-bis(4-hydroxyphenyl)butane, 1,4-bis(4-hydroxyphenyl)butane, 2,2-bis(4-hydroxyphenyl)pentane, 4-methyl-2,2-bis(4-hydroxyphenyl)pentane, 2,2-bis(4-hydroxyphenyl)hexane, 4,4-bis(4-hydroxyphenyl)heptane, 2,2-bis(4-hydroxyphenyl)nonane, 1,10-bis(4-hydroxyphenyl)decane, 1,1-bis(4-hydroxyphenyl)-3,3,5-trimethylcyclohexane, and 2,2-bis(4-hydroxyphenyl)-1,1,1,3,3,3-hexafluoropropane; dihyroxydiarylcycloalkanes such as 1,1-bis(4-hydroxyphenyl)cyclohexane, 1,1-bis(3,5-dichloro-4-hydroxyphenyl)cyclohexane, and 1,1-bis(4-hydroxyphenyl)cyclodecane; dihydroxydiarylsulfones such as bis(4-hydroxyphenyl)sulfone, and bis(3,5-dimethyl-4-hydroxyphenyl)sulfone, bis(3-chloro-4-hydroxyphenyl)sulfone; dihydroxydiarylethers such as bis(4-hydroxyphenyl)ether, and bis(3-5-dimethyl-4-hydroxyphenyl)ether; dihydroxydiaryl ketones such as 4,4′-dihydroxybenzophenone, and 3,3′,5,5′-tetramethyl-4,4-dihydroxybenzophenone; dihydroxydiaryl sulfides such as bis(4-hydroxyphenyl)sulfide, bis(3-methyl-4-hydroxyphenyl)sulfide, and bis(3,5-dimethyl-4-hydroxyphenyl)sulfide; dihydroxydiaryl sulfoxides such as bis(4-hydroxyphenyl)sulfoxide; dihydroxydiphenyls such as 4,4′-dihydroxyphenyl; dihydroxyarylfluorenes such as 9,9-bis(4-hydroxyphenyl)fluorene; dihydroxybenzenes such as hydroxyquinone, resorcinol, and methylhydroxyquinone; and dihydroxynaphthalenes such as 1,5-dihydroxynaphthalene and 2,6-dihydroxynaphthalene. Also, two or more kinds of dihydroxy compounds can be combined as needed.

In a specific embodiment, the polyester is a terephthalate-derived polyester or a mixture of terephthalate-derived polyesters. Terephthalate-derived polyesters are polyesters prepared from terephthalic acid or C₁-C₆-dialkyl terephthalate such as dimethyl terephthalate or the like, including poly(ethylene terephthalate) (PET), poly(1,4-butylene terephthalate) (PBT), PBT made from recycled PET, poly(1,3-propylene terephthalate) (PPT), and poly(cyclohexylenedimethylene terephthalate) (PCT), polytrimethylene terephthalate (PTT), glycol modified polycyclohexylenedimethylene terephthalate (PCTG) or glycol-modified polyethylene terephthalate (PETG), or combinations thereof. In one embodiment, the polyester is PET, PBT, PBT made from recycled PET, PCT, or PCTG. More particularly, the terephthalate derived polyester is PET or PBT.

Polyesters that are used this invention can be a single kind of thermoplastic polyester used alone, or two or more kinds used in combination. Furthermore, copolyesters can also be used as needed.

In one embodiment, the composition comprises about 30 to about 80 percent by weight of a polyester based on the total weight of the composition. In another embodiment, the composition comprises 40 to about 70 percent by weight of a polyester. In another embodiment, the composition comprises 50 to about 60 percent by weight of a polyester. In another embodiment, the composition comprises 52 to about 58 percent by weight of a polyester. In another embodiment, the composition comprises 54 to about 57 percent by weight of a polyester. In a particular embodiment, the polyester is PBT. More specifically, the polyester is PBT with a weight average molecular weight (Mw) of 10,000 to 150,000, and more specifically from 40,000 to 110,000.

In a particular embodiment, the composition comprises PBT which is a mixture containing 4 to 8 percent and more particularly 6 percent by weight of PBT with an intrinsic viscosity of 1.2 cm³/g as measured in a 60:40 phenol/tetrachloroethane mixture (available from SABIC Innovative Plastics as PBT 315); and 47-62 percent by weight of PBT with an intrinsic viscosity of 0.66 cm³/g as measured in a 60:40 phenol/tetrachloroethane mixture (available from SABIC Innovative Plastics as PBT 195).

In another particular embodiment, the composition comprises PBT which is a mixture containing 6 percent PBT with an intrinsic viscosity of 1.2 cm³/g as measured in a 60:40 phenol/tetrachloroethane mixture (available from SABIC Innovative Plastics as PBT 315); and 47 to 52 percent by weight of PBT with an intrinsic viscosity of 0.66 cm³/g as measured in a 60:40 phenol/tetrachloroethane mixture (available from SABIC Innovative Plastics as PBT 195).

In another particular embodiment, the composition comprises PBT which is a mixture containing 6 percent PBT with an intrinsic viscosity of 1.2 cm³/g as measured in a 60:40 phenol/tetrachloroethane mixture (available from SABIC Innovative Plastics as PBT 315); and 49 to 52 percent by weight of PBT with an intrinsic viscosity of 0.66 cm³/g as measured in a 60:40 phenol/tetrachloroethane mixture (available from SABIC Innovative Plastics as PBT 195).

In another particular embodiment, the composition comprises 49 to 62 percent by weight PBT with an intrinsic viscosity of 0.66 cm³/g as measured in a 60:40 phenol/tetrachloroethane mixture (available from SABIC Innovative Plastics as PBT 195). In another particular embodiment, the composition comprises 49 to 58 percent by weight PBT with an intrinsic viscosity of 0.66 cm³/g as measured in a 60:40 phenol/tetrachloroethane mixture (available from SABIC Innovative Plastics as PBT 195). In another particular embodiment, the composition comprises 52 to 58 percent by weight PBT with an intrinsic viscosity of 0.66 cm³/g as measured in a 60:40 phenol/tetrachloroethane mixture (available from SABIC Innovative Plastics as PBT 195).

### Brominated Flame Retardant Compound

In addition to the polyester, the composition contains a brominated flame retardant compound. Brominated flame retardant compounds useful in the practice of this invention include tetrabromobisphenol A polycarbonate oligomer, polybromophenyl ether, brominated polystyrene, brominated bisphenol A polyepoxide, brominated imides, brominated polycarbonate, poly (bromoaryl acrylate), poly (bromoaryl methacrylate), or mixtures thereof.

Other suitable flame retardants are brominated polystyrenes such as polydibromostyrene and polytribromostyrene, decabromobiphenyl ethane, tetrabromobiphenyl, brominated alpha, omega-alkylene-bis-phthalimides, e.g., N,N′-ethylene-bis-tetrabromophthalimide, oligomeric brominated carbonates, especially carbonates derived from tetrabromobisphenol A, which, if desired, are end-capped with phenoxy radicals, or with brominated phenoxy radicals, or brominated epoxy resins.

In another embodiment, the brominated flame retardant compound is selected from the group consisting of decabromodiphenyl ether (Deca-BDE), decabromodiphenyl ethane (DBDPE), poly(pentabromobenzylacrylate (Br-acrylate), tetrabromobisphenol A (TBBPA), TBBPA oligomer, hexabromocyclododecane (HBCD), polybromophenyl ether, tetrabromo bisphenol A-tetrabromobisphenol A diglycidyl ether (brominated epoxide), brominated polystyrene (Br-PS), brominated imide, brominated polycarbonate(Br-PC), 2,4,6-tribromophenyl terminated TBBPA, TBBPA carbonate oligomer, or combinations thereof.

More particularly, the brominated flame retardant compound is selected from the group consisting of phenoxy-terminated tetrabrombisphenol A carbonate oligomer (TBBPA) which is available as BC-52, CAS Reg. No. 71342-77-3 from ICL-IP; 2,4,6-tribromophenyl-terminated tetrabrombisphenol A carbonate oligomer, which is available as BC-58, CAS Reg. No. 71342773, from ICL-IP; decabromodiphenylethane (DBDPE), CAS Reg. No. 84852-53-9, from Albemarle Corporation; poly(pentabromobenzylacrylate) (Br-Acrylate) CAS Reg. No. 59447-57-3, from ICL-IP; tetrabromo bisphenol A-tetrabromobisphenlo A diglycidyl ether (Br-Epoxy), CAS Reg. No. 68928-70-1, from Sakamoto Yakuhin Kogyo; brominated polystyrene (Br-PS), CAS Reg. No. 88497-56-7, from Albemarle Corporation; and brominated polycarbonate (Br-PC) which is a copolymer comprising units of bisphenol A (CAS Reg. No. 111211-39-3) and tetrabromobisphenol A, 24-29 percent bromine by weight (CAS Reg. No. 156042-31-8).

In one embodiment, the brominated polycarbonate is a copolycarbonate prepared from brominated and unbrominated dihydroxy compounds. In this embodiment, the ratio of brominated units to unbrominated units in the copolycarbonate is chosen to provide an amount of bromine of about 1 to about 45 percent by weight, preferably about 10 to about 40 percent by weight, more preferably about 15 to about 35 percent by weight, and yet more preferably about 20 to about 30 percent by weight based on the total weight of the copolycarbonate. A preferred brominated polycarbonate is a copolycarbonate comprising structural units derived from bisphenol A and tetrabromobisphenol A.

In another embodiment, the brominated flame retardant compound is phenoxy-terminated tetrabrombisphenol A carbonate oligomer (TBBPA) or brominated polystyrene (Br-PS). More particularly, the composition contains about 3 to about 30 percent by weight of the brominated flame retardant compound based on the total weight of the composition. In another embodiment, the composition comprises about 6 to about 17 percent by weight of the brominated flame retardant compound. In another embodiment, the composition comprises about 8 to about 14 percent by weight of the brominated flame retardant compound. In another embodiment, the composition comprises about 10 to about 12 percent by weight of the brominated flame retardant compound.

### Alkali Metal Carbonate

In addition to the polyester and brominated flame retardant compound, the composition contains an alkali metal carbonate. Alkali metal carbonates are carbonates of the Periodic Table Group 1 metal elements. The Periodic Table Group 1 metal elements include Li, Na, K, Rb, and Cs. The corresponding carbonates include lithium carbonate (Li₂CO₃), sodium carbonate (Na₂CO₃), potassium carbonate (K₂CO₃), rubidium carbonate (Rb₂CO₃), and cesium carbonate (Cs₂CO₃). Preferably, the carbonate that is used is lithium carbonate, sodium carbonate, or potassium carbonate or a mixture thereof. More preferably, the carbonate is sodium carbonate or potassium carbonate. Typically, the alkali metal carbonate that is used in the composition is sodium carbonate or potassium carbonate, or a mixture thereof. In a particular embodiment, the composition contains 0.03 to 0.9 percent by weight of sodium carbonate or potassium carbonate or a mixture thereof. More particularly, the composition contains 0.03 to 0.8 percent by weight of sodium carbonate or potassium carbonate or a mixture thereof.

### Antimony Flame Retardant Compound

In addition to the polyester, brominated flame retardant compound, and alkali metal carbonate, the composition contains an antimony flame retardant compound. “Antimony flame retardant compound” means a flame retardant compound such as antimony trioxide (Sb₂O₃), antimony pentoxide (Sb₂O₅), and antimony-metal compounds, such as sodium antimonate (Na₂SbO₄). In one embodiment, the antimony flame retardant compound is Sb₂O₃.

In one embodiment, the composition comprises about 0.1 to about 5 percent by weight of Sb₂O₃ based on the total weight of the composition. In another embodiment, the composition comprises about 0.5 to about 4.5 percent by weight of Sb₂O₃. In another embodiment, the composition comprises about 1 to about 4 percent by weight of Sb₂O₃. In another embodiment, the composition comprises about 1 to about 2 percent by weight of Sb₂O₃.

### Other Ingredients

The composition of the present invention may include additives which do not interfere with the previously mentioned desirable properties but enhance other favorable properties such as anti-oxidants, flame retardants, reinforcing materials, colorants, mold release agents such as low density polyethylene, fillers, nucleating agents, heat stabilizers, lubricants, and the like. Additionally, additives such as antioxidants, and other stabilizers including but not limited to UV stabilizers, such as benzotriazole, pigments or combinations thereof may be added to the compositions of the present invention. The additives can be present in an amount between about 0 and about 50 percent by weight. The different additives that can be incorporated in the compositions are commonly used and known to one skilled in the art. Illustrative descriptions of such additives may be found in R. Gachter and H. Muller, Plastics Additives Handbook, 6th edition, 2009.

For example, the composition may optionally contain a stabilizer. In one embodiment, the stabilizer is pentaerythritol tetrakis(3,5-di-tert-butyl-4-hydroxyhydrocinnamate), CAS Reg. No. 6683-19-8. In a further embodiment, about 0.04 to 0.1 percent by weight of the stabilizer is present based on the total weight of the composition and the stabilizer is pentaerythritol tetrakis(3,5-di-tert-butyl-4-hydroxyhydrocinnamate).

The composition may also optionally contain a filler such as alumina, amorphous silica, anhydrous aluminum silicates, mica, feldspar, clays, talc, glass flake, glass microspheres, wollastonite, metal oxides such as titanium dioxide, zinc oxide, ground quartz, and the like. A preferred optional, additional filler is talc. The talc may be coated, surface treated, or untreated. A variety of treated talcs are commercially available, for instance, from Mineral Technologies, Inc. or other vendors such as Luzenac, Inc. In a particular embodiment, the composition contains 1 to 5 percent by weight of talc. In a more particular embodiment, the composition contains 1.5 to 3 percent by weight of talc.

The composition may optionally also contain glass. Glass in the form of glass fibers may be composed of E-glass or alkali metal silicate glass and may comprise short, chopped glass fibers with a circular cross section ranging in diameter from about 2×10⁻⁴ to 8×10⁻⁴ inch and about 0.2 to 2 cm in length. Such glass fibers can be supplied by the manufacturers with a surface treatment compatible with the polymer component of the composition, such as a siloxane or polyurethane sizing. Glass fibers may be composed of E-glass or alkali metal silicate glass and may comprise short, chopped glass fibers with a circular cross section ranging in diameter from about 2×10⁻⁴ to 8×10⁻⁴ inch and about 0.2 to 2 cm in length. Such glass fibers can be supplied by the manufacturers with a surface treatment compatible with the polymer component of the composition, such as a siloxane or polyurethane sizing.

In one embodiment, the glass fiber is borosilicate glass fiber (CAS Reg. No. 65997-17-3) not having a surface treatment, obtained from Chongqing Polycomp International Corp. When used in the composition, the glass fiber is normally included at a level of from about 0 to 50 percent by weight, more preferably from about 5 to 45 percent by weight, and more preferably 20 to about 40 percent, and more preferably 25 to about 35 percent by weight based on the total weight of the composition.

The composition may optionally further contain an antidrip agent. The term “antidrip” refers to an additive which increases the melt strength of the polycarbonate, thereby reducing the tendency of the resin, when heated to close to melting, to drip. Examples of suitable antidrip agents include polyfluorotetraethylene (PTFE), as well as PTFE-based antidrip agents, such as 1/1 dispersion of PTFE in styrene acrylonitrile resin, emulsion based PTFE, and steam-precipitated PTFE.

### Method

In one aspect, the invention provides a method of reducing the amount of antimony flame retardant compound in a flame retardant composition which comprises using a combination of an alkali metal carbonate with a brominated flame retardant compound in the composition, wherein the composition comprises:
(a) 30 to 80 percent by weight of a polyester;
(b) 3 to 30 percent by weight of a brominated flame retardant compound;
(c) 0.1 to 5 percent by weight of an antimony flame retardant compound;
(d) 0.03 to 0.9 percent by weight of an alkali metal carbonate;
(e) 0 to 50 percent by weight of glass fiber; and wherein:
   (i) the composition meets or exceeds the requirements of UL94-V2;
   (ii) less antimony retardant compound is present in the composition comprising (a), (b), (c), and (d) as compared to a composition comprising component (a), (b), (c) and no (d);
   (iii) the comparative tracking index (CTI) for a composition comprising (a), (b), (c), and (d) is the same as or greater than the CTI of a composition comprising component (a), (b), (c) and no (d);
   (iv) the composition does not contain a phosphorous containing flame retardant;
   and wherein the percent by weights are based on the total weight of the composition.

In one embodiment of this method, the polyester is a terephthalate-derived polyester. In a more particular embodiment, the terephthalate-derived polyester is selected from the group consisting of PET, PBT, PBT made from recycled PET, PCT, and PCTG, or a combination thereof. More particularly, the polyester is PET, PBT, PBT made from recycled PET, or a combination thereof. Even more particularly, the polyester is PBT.

In another particular embodiment, the composition comprises PBT which is a mixture containing 4 to 8 percent by weight and more particularly 6 percent by weight of PBT with an intrinsic viscosity of 1.2 cm³/g as measured in a 60:40 phenol/tetrachloroethane mixture (available from SABIC Innovative Plastics as PBT 315); and 47-62 percent by weight of PBT with an intrinsic viscosity of 0.66 cm³/g as measured in a 60:40 phenol/tetrachloroethane mixture (available from SABIC Innovative Plastics as PBT 195). In another particular embodiment, the composition comprises PBT which is a mixture containing 6 percent PBT with an intrinsic viscosity of 1.2 cm³/g as measured in a 60:40 phenol/tetrachloroethane mixture (available from SABIC Innovative Plastics as PBT 315); and 47-52 percent by weight of PBT with an intrinsic viscosity of 0.66 cm³/g as measured in a 60:40 phenol/tetrachloroethane mixture. In another particular embodiment, the composition comprises PBT which is a mixture containing 6 percent PBT with an intrinsic viscosity of 1.2 cm³/g as measured in a 60:40 phenol/tetrachloroethane mixture; and 49-52 percent by weight of PBT with an intrinsic viscosity of 0.66 cm³/g as measured in a 60:40 phenol/tetrachloroethane mixture.

In another particular embodiment, the composition comprises 49 to 62 by weight of PBT which has an intrinsic viscosity of 0.66 cm³/g as measured in a 60:40 phenol/tetrachloroethane mixture (available from SABIC Innovative Plastics as PBT 195). In another particular embodiment, the composition comprises 49 to 59 by weight of PBT which has an intrinsic viscosity of 0.66 cm³/g as measured in a 60:40 phenol/tetrachloroethane mixture. In another particular embodiment, the composition comprises 52 to 58 by weight of PBT which has an intrinsic viscosity of 0.66 cm³/g as measured in a 60:40 phenol/tetrachloroethane mixture.

In another embodiment, the brominated flame retardant compound is selected from the group consisting of DBDPE, TBBPA carbonate oligomer, 2,4,6-tribromophenyl terminated TBBPA, Br-acrylate, Br-epoxy, Br-PS, and Br-PC, or combinations thereof. In another embodiment, the brominated flame retardant compound is TBBPA carbonate oligomer. In another embodiment, the brominated flame retardant compound is Br-PS. In another embodiment, the brominated flame retardant compound is Br-acrylate.

In another embodiment, the antimony flame retardant compound is antimony trioxide (Sb₂O₃).

In another embodiment, the alkali metal carbonate is sodium carbonate or potassium carbonate or a mixture thereof. In another embodiment, the alkali metal carbonate is potassium carbonate. In another embodiment, the alkali metal carbonate is sodium carbonate.

In a particular further embodiment, the composition optionally further comprises a mold release agent. In a particular embodiment, the mold release agent is low density polyethylene (LDPE). In a further particular embodiment, the composition comprises 0.1 to 0.3 percent by weight of a mold release agent which is low density polyethylene (LDPE).

In another embodiment of the method, the composition comprises:
(a) 40 to 70 percent by weight of a polyester;
(b) 3 to 30 percent by weight of a brominated flame retardant compound;
(c) 0.1 to 5 percent by weight of an antimony flame retardant compound;
(d) 0.03 to 0.9 percent by weight of an alkali metal carbonate;
(e) 0 to 50 percent by weight of glass fiber; and

wherein requirements (i)-(iv) are met and the percent by weights are based on the total weight of the composition.

In another embodiment of the method, the composition comprises:
(a) 40 to 70 percent by weight of a polyester;
(b) 6 to 17 percent by weight of a brominated flame retardant compound;
(c) 0.1 to 5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment of the method, the composition comprises:
(a) 40 to 70 percent by weight of a polyester;
(b) 6 to 17 percent by weight of a brominated flame retardant compound;
(c) 0.5 to 4.5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment of the method, the composition comprises:
(a) 50 to 60 percent by weight of a polyester;
(b) 6 to 17 percent by weight of a brominated flame retardant compound;
(c) 0.5 to 4.5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment of the method, the composition comprises:
(a) 50 to 60 percent by weight of a polyester;
(b) 8 to 14 percent by weight of a brominated flame retardant compound;
(c) 0.5 to 4.5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment of the method, the composition comprises:
(a) 50 to 60 percent by weight of a polyester;
(b) 8 to 14 percent by weight of a brominated flame retardant compound;
(c) 1 to 4 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment of the method, the composition comprises:
(a) 50 to 60 percent by weight of a polyester;
(b) 9 to 12 percent by weight of a brominated flame retardant compound;
(c) 1.25 to 2.5 percent by weight of an antimony flame retardant compound;
(d) 0.03 to 0.8 percent by weight of an alkali metal carbonate;
(e) 0 to 50 percent by weight of glass fiber; and
   wherein requirements (i)-(iv) are met and the percent by weights are based on the total weight of the composition.

In another embodiment of the method, the composition comprises:
(a) 50 to 60 percent by weight of PBT;
(b) 9 to 12 percent by weight of a brominated flame retardant compound;
(c) 1.25 to 2.5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment of the method, the composition comprises:
(a) 49 to 52 percent by weight of PBT with an intrinsic viscosity of 0.66 cm³/g as measured in a 60:40 phenol/tetrachloroethane mixture and 6 percent by weight of PBT with an intrinsic viscosity of 1.2 cm³/g as measured in a 60:40 phenol/tetrachloroethane mixture;
(b) 9 to 12 percent by weight of a brominated flame retardant compound;
(c) 1.25 to 2.5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment of the method, the composition comprises:
(a) 52 to 58 percent by weight of PBT with an intrinsic viscosity of 0.66 cm³/g as measured in a 60:40 phenol/tetrachloroethane mixture;
(b) 9 to 12 percent by weight of a brominated flame retardant compound;
(c) 1.25 to 2.5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In these and other embodiments, the brominated flame retardant compound is selected from the group consisting of DBDPE, TBBPA carbonate oligomer, 2,4,6-tribromophenyl terminated TBBPA, Br-acrylate, Br-epoxy, Br-PS, and Br-PC, or combinations thereof. In another embodiment, the brominated flame retardant compound is TBBPA carbonate oligomer. In another embodiment, the brominated flame retardant compound is Br-PS. In another embodiment, the brominated flame retardant compound is Br-acrylate.

In another embodiment of the method, the composition comprises:
(a) 49 to 52 percent by weight of PBT with an intrinsic viscosity of 0.66 cm³/g as measured in a 60:40 phenol/tetrachloroethane mixture and 6 percent by weight of PBT with an intrinsic viscosity of 1.2 cm³/g as measured in a 60:40 phenol/tetrachloroethane mixture;
(b) 9 to 12 percent by weight of TBBPA;
(c) 1.25 to 2.5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment of the method, the composition comprises:
(a) 49 to 62 percent by weight of PBT;
(b) 9 to 12 percent by weight of TBBPA, poly(pentabromobenzylacrylate) or brominated polystyrene;
(c) 1.25 to 2.5 percent by weight of an antimony flame retardant compound;
(d) 0.03 to 0.8 percent by weight of sodium carbonate or potassium carbonate; and
(e) 0 to 50 percent by weight of glass fiber; and

wherein requirements (i)-(iv) are met and the percent by weights are based on the total weight of the composition.

In another embodiment of the method, the composition comprises:
(a) 49 to 58 percent by weight of PBT with an intrinsic viscosity of 0.66 cm³/g as measured in a 60:40 phenol/tetrachloroethane mixture;
(b) 9 to 12 percent by weight of TBBPA, poly(pentabromobenzylacrylate) or brominated polystyrene;
(c) 1.25 to 2.5 percent by weight of an antimony flame retardant compound;
(d) 0.03 to 0.8 percent by weight of sodium carbonate or potassium carbonate;
(e) 0 to 50 percent by weight of glass fiber; and

wherein requirements (i)-(iv) are met and the percent by weights are based on the total weight of the composition.

In another embodiment of the method, the composition comprises:
(a) 52 to 58 percent by weight of PBT with an intrinsic viscosity of 0.66 cm³/g as measured in a 60:40 phenol/tetrachloroethane mixture;
(b) 9 to 12 percent by weight of TBBPA, of poly(pentabromobenzylacrylate) or brominated polystyrene;
(c) 1.25 to 2.5 percent by weight of Sb₂O₃;
(d) 0.03 to 0.8 percent by weight of sodium carbonate or potassium carbonate; and
(e) 0 to 50 percent by weight of glass fiber; and

wherein requirements (i)-(iv) are met and the percent by weights are based on the total weight of the composition.

In the above embodiments and other embodiments of the method, the composition optionally further comprises a mold release agent. In a particular embodiment, the mold release agent is low density polyethylene (LDPE). In a further particular embodiment, the composition comprises 0.1 to 0.3 percent by weight of a mold release agent which is low density polyethylene (LDPE).

Thus, in another embodiment of the method, the composition comprises:
(a) 49 to 52 percent by weight of PBT with an intrinsic viscosity of 0.66 cm³/g as measured in a 60:40 phenol/tetrachloroethane mixture and 6 percent by weight of PBT with an intrinsic viscosity of 1.2 cm3/g as measured in a 60:40 phenol/tetrachloroethane mixture;
(b) 9 to 12 percent by weight of TBBPA;
(c) 1.25 to 2.5 percent by weight of Sb₂O₃;
(d) 0.03 to 0.8 percent by weight of sodium carbonate or potassium carbonate;
(e) 0 to 50 percent by weight of glass fiber;
(f) 0.1 to 0.3 of a mold release agent; and

wherein requirements (i)-(iv) are met and the percent by weights are based on the total weight of the composition.

In another embodiment of the method, the composition comprises:
(a) 52 to 58 percent by weight of PBT with an intrinsic viscosity of 0.66 cm³/g as measured in a 60:40 phenol/tetrachloroethane mixture;
(b) 9 to 12 percent by weight of poly(pentabromobenzylacrylate) or brominated polystyrene;
(c) 1.25 to 2.5 percent by weight of Sb₂O₃;
(d) 0.03 to 0.8 percent by weight of sodium carbonate or potassium carbonate;
(e) 0 to 50 percent by weight of glass fiber;
(f) 0.1 to 0.3 percent by weight of a LDPE; and

wherein requirements (i)-(iv) are met and the percent by weights are based on the total weight of the composition.

In the above embodiments and other embodiments of the method, the composition may optionally contain a filler. A preferred filler is talc. The talc may be coated, surface treated, or untreated. A variety of treated talcs are commercially available, for instance, from Mineral Technologies, Inc. In a particular embodiment, the composition contains 1 to 5 percent by weight of talc. In a more particular embodiment, the composition contains 1.5 to 3 percent by weight of talc.

Thus, in another embodiment, the composition comprises:
(a) 49 to 52 percent by weight of PBT with an intrinsic viscosity of 0.66 cm³/g as measured in a 60:40 phenol/tetrachloroethane mixture and 6 percent by weight of PBT with an intrinsic viscosity of 1.2 cm3/g as measured in a 60:40 phenol/tetrachloroethane mixture;
(b) 9 to 12 percent by weight of TBBPA or brominated polystyrene;
(c) 1.25 to 2.5 percent by weight of Sb₂O₃;
(d) 0.03 to 0.8 percent by weight of sodium carbonate or potassium carbonate;
(e) 0 to 50 percent by weight of glass fiber;
(f) 0.1 to 0.3 percent by weight of a LDPE;
(g) 1 to 5 percent by weight of talc; and

wherein requirements (i)-(iv) are met and the percent by weights are based on the total weight of the composition.

In another embodiment of the method, the composition comprises:
(a) 52 to 58 percent by weight of PBT with an intrinsic viscosity of 0.66 cm³/g as measured in a 60:40 phenol/tetrachloroethane mixture;
(b) 9 to 12 percent by weight of poly(pentabromobenzylacrylate) or brominated polystyrene;
(c) 1.25 to 2.5 percent by weight of Sb₂O₃;
(d) 0.03 to 0.8 percent by weight of sodium carbonate or potassium carbonate;
(e) 0 to 50 percent by weight of glass fiber;
(f) 0 to 0.3 percent by weight of a LDPE;
(g) 1.5 to 3 percent by weight of talc; and

wherein requirements (i)-(iv) are met and the percent by weights are based on the total weight of the composition.

In the above embodiments, the glass fiber, when present, is borosilicate glass fiber (CAS Reg. No. 65997-17-3) not having a surface treatment, obtained from Chongqing Polycomp International Corp. When used in the composition, the glass fiber is normally included at a level of from about 1 to 50 percent by weight, more preferably from about 5 to 45 percent by weight, and more preferably 20 to about 40 percent by weight, and more preferably 25 to about 35 percent by weight based on the total weight of the composition.

Thus, in another embodiment, the composition comprises:
(a) 49 to 52 percent by weight of PBT with an intrinsic viscosity of 0.66 cm³/g as measured in a 60:40 phenol/tetrachloroethane mixture and 6 percent by weight of PBT with an intrinsic viscosity of 1.2 cm3/g as measured in a 60:40 phenol/tetrachloroethane mixture;
(b) 9 to 12 percent by weight of TBBPA or brominated polystyrene;
(c) 1.25 to 2.5 percent by weight of Sb₂O₃;
(d) 0.03 to 0.8 percent by weight of sodium carbonate or potassium carbonate;
(e) 20 to 40 percent by weight of glass fiber; and wherein:
(f) 0.1 to 0.3 percent by weight of a LDPE;
(g) 1 to 5 percent by weight of talc; and

wherein requirements (i)-(iv) are met and the percent by weights are based on the total weight of the composition.

In another embodiment of the method, the composition comprises:
(a) 52 to 58 percent by weight of PBT with an intrinsic viscosity of 0.66 cm³/g as measured in a 60:40 phenol/tetrachloroethane mixture;
(b) 9 to 12 percent by weight of TBBPA, 9 to 12 percent by weight of TBBPA, poly(pentabromobenzylacrylate) or brominated polystyrene;
(c) 1.25 to 2.5 percent by weight of Sb₂O₃;
(d) 0.03 to 0.8 percent by weight of sodium carbonate or potassium carbonate;
(e) 25 to 35 percent by weight of glass fiber; and wherein:
(f) 0 to 0.3 percent by weight of a LDPE;
(g) 1.5 to 3 percent by weight of talc; and

wherein requirements (i)-(iv) are met and the percent by weights are based on the total weight of the composition.

In another embodiment of the method, the composition comprises:
(a) 52 to 58 percent by weight of PBT with an intrinsic viscosity of 0.66 cm³/g as measured in a 60:40 phenol/tetrachloroethane mixture;
(b) 9 to 12 percent by weight of poly(pentabromobenzylacrylate) or brominated polystyrene;
(c) 1.25 to 2.5 percent by weight of Sb₂O₃;
(d) 0.03 to 0.8 percent by weight of sodium carbonate or potassium carbonate;
(e) 25 to 35 percent by weight of glass fiber;
(f) 1.5 to 3 percent by weight of talc; and

wherein requirements (i)-(iv) are met and the percent by weights are based on the total weight of the composition.

### Composition

In another aspect, the invention provides a flame retardant composition, wherein the composition comprises:
(a) 30 to 80 percent by weight of a polyester;
(b) 3 to 30 percent by weight of a brominated flame retardant compound;
(c) 0.1 to 5 percent by weight of an antimony flame retardant compound;
(d) 0.03 to 0.9 percent by weight of an alkali metal carbonate; and
(e) 0 to 50 percent by weight of glass fiber; and wherein:
   (i) the composition meets or exceeds the requirements of UL94-V2;
   (ii) less antimony retardant compound is present in the composition comprising (a), (b), (c), and (d) as compared to a composition comprising component (a), (b), (c) and no (d);
   (iii) the comparative tracking index (CTI) for a composition comprising (a), (b), (c), and (d) is the same as or greater than the CTI of a composition comprising component (a), (b), (c) and no (d);
   (iv) the composition does not contain a phosphorous containing flame retardant;

and wherein the percent by weights are based on the total weight of the composition.

In one embodiment of this composition, the polyester is a terephthalate-derived polyester. In a more particular embodiment, the terephthalate-derived polyester is selected from the group consisting of PET, PBT, PBT made from recycled PET, PCT, and PCTG, or a combination thereof. More particularly, the polyester is PET, PBT, or a combination thereof. Even more particularly, the polyester is PBT.

In another particular embodiment, the composition comprises PBT which is a mixture containing 4 to 8 percent by weight and more particularly 6 percent by weight of PBT with an intrinsic viscosity of 1.2 cm³/g as measured in a 60:40 phenol/tetrachloroethane mixture (available from SABIC Innovative Plastics as PBT 315); and 47-62 percent by weight of PBT with an intrinsic viscosity of 0.66 cm³/g as measured in a 60:40 phenol/tetrachloroethane mixture (available from SABIC Innovative Plastics as PBT 195). In another particular embodiment, the composition comprises PBT which is a mixture containing 6 percent PBT with an intrinsic viscosity of 1.2 cm³/g as measured in a 60:40 phenol/tetrachloroethane mixture (available from SABIC Innovative Plastics as PBT 315); and 47-52 percent by weight of PBT with an intrinsic viscosity of 0.66 cm³/g as measured in a 60:40 phenol/tetrachloroethane mixture. In another particular embodiment, the composition comprises PBT which is a mixture containing 6 percent PBT with an intrinsic viscosity of 1.2 cm³/g as measured in a 60:40 phenol/tetrachloroethane mixture; and 49-52 percent by weight of PBT with an intrinsic viscosity of 0.66 cm³/g as measured in a 60:40 phenol/tetrachloroethane mixture.

In another particular embodiment, the composition comprises 49 to 62 by weight of PBT which has an intrinsic viscosity of 0.66 cm³/g as measured in a 60:40 phenol/tetrachloroethane mixture (available from SABIC Innovative Plastics as PBT 195). In another particular embodiment, the composition comprises 49 to 59 by weight of PBT which has an intrinsic viscosity of 0.66 cm³/g as measured in a 60:40 phenol/tetrachloroethane mixture. In another particular embodiment, the composition comprises 51 to 57 by weight of PBT which has an intrinsic viscosity of 0.66 cm³/g as measured in a 60:40 phenol/tetrachloroethane mixture.

In another embodiment, the brominated flame retardant compound is selected from the group consisting of DBDPE, TBBPA carbonate oligomer, 2,4,6-tribromophenyl terminated TBBPA, Br-acrylate, Br-epoxy, Br-PS, and Br-PC, or combinations thereof. In another embodiment, the brominated flame retardant compound is TBBPA carbonate oligomer. In another embodiment, the brominated flame retardant compound is Br-PS. In another embodiment, the brominated flame retardant compound is Br-acrylate.

In another embodiment, the antimony flame retardant compound is antimony trioxide (Sb₂O₃).

In another embodiment, the alkali metal carbonate is sodium carbonate or potassium carbonate or a mixture thereof. In another embodiment, the alkali metal carbonate is potassium carbonate. In another embodiment, the alkali metal carbonate is sodium carbonate.

In a particular further embodiment, the composition optionally further comprises a mold release agent. In a particular embodiment, the mold release agent is low density polyethylene (LDPE). In a further particular embodiment, the composition comprises 0.1 to 0.3 percent by weight of a mold release agent which is low density polyethylene (LDPE).

In another embodiment, the composition comprises:
(a) 40 to 70 percent by weight of a polyester;
(b) 3 to 30 percent by weight of a brominated flame retardant compound;
(c) 0.1 to 5 percent by weight of an antimony flame retardant compound;
(d) 0.03 to 0.9 percent by weight of an alkali metal carbonate;
(e) 0 to 50 percent by weight of glass fiber; and

wherein requirements (i)-(iv) are met and the percent by weights are based on the total weight of the composition.

In another embodiment, the composition comprises:
(a) 40 to 70 percent by weight of a polyester;
(b) 6 to 17 percent by weight of a brominated flame retardant compound;
(c) 0.1 to 5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment, the composition comprises:
(a) 40 to 70 percent by weight of a polyester;
(b) 6 to 17 percent by weight of a brominated flame retardant compound;
(c) 0.5 to 4.5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment, the composition comprises:
(a) 50 to 60 percent by weight of a polyester;
(b) 6 to 17 percent by weight of a brominated flame retardant compound;
(c) 0.5 to 4.5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment, the composition comprises:
(a) 50 to 60 percent by weight of a polyester;
(b) 8 to 14 percent by weight of a brominated flame retardant compound;
(c) 0.5 to 4.5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment, the composition comprises:
(a) 50 to 60 percent by weight of a polyester;
(b) 8 to 14 percent by weight of a brominated flame retardant compound;
(c) 1 to 4 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment, the composition comprises:
(a) 50 to 60 percent by weight of a polyester;
(b) 9 to 12 percent by weight of a brominated flame retardant compound;
(c) 1.25 to 2.5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment, the composition comprises:
(a) 50 to 60 percent by weight of PBT;
(b) 9 to 12 percent by weight of a brominated flame retardant compound;
(c) 1.25 to 2.5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment, the composition comprises:
(a) 49 to 52 percent by weight of PBT with an intrinsic viscosity of 0.66 cm³/g as measured in a 60:40 phenol/tetrachloroethane mixture and 6 percent by weight of PBT with an intrinsic viscosity of 1.2 cm³/g as measured in a 60:40 phenol/tetrachloroethane mixture;
(b) 9 to 12 percent by weight of a brominated flame retardant compound;
(c) 1.25 to 2.5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment, the composition comprises:
(a) 52 to 58 percent by weight of PBT with an intrinsic viscosity of 0.66 cm³/g as measured in a 60:40 phenol/tetrachloroethane mixture;
(b) 9 to 12 percent by weight of a brominated flame retardant compound;
(c) 1.25 to 2.5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In these and other embodiments, the brominated flame retardant compound is selected from the group consisting of DBDPE, TBBPA carbonate oligomer, 2,4,6-tribromophenyl terminated TBBPA, Br-acrylate, Br-epoxy, Br-PS, and Br-PC, or combinations thereof. In another embodiment, the brominated flame retardant compound is TBBPA carbonate oligomer. In another embodiment, the brominated flame retardant compound is Br-PS. In another embodiment, the brominated flame retardant compound is Br-acrylate.

In another embodiment, the composition comprises:
(a) 49 to 52 percent by weight of PBT with an intrinsic viscosity of 0.66 cm³/g as measured in a 60:40 phenol/tetrachloroethane mixture and 6 percent by weight of PBT with an intrinsic viscosity of 1.2 cm³/g as measured in a 60:40 phenol/tetrachloroethane mixture;
(b) 9 to 12 percent by weight of TBBPA;
(c) 1.25 to 2.5 percent by weight of an antimony flame retardant compound;
(d) 0.03 to 0.8 percent by weight of an alkali metal carbonate;
(e) 0 to 50 percent by weight of glass fiber; and

wherein requirements (i)-(iv) are met and the percent by weights are based on the total weight of the composition.

In another embodiment, the composition comprises:
(a) 49 to 62 percent by weight of PBT;
(b) 9 to 12 percent by weight of TBBPA, poly(pentabromobenzylacrylate) or brominated polystyrene;
(c) 1.25 to 2.5 percent by weight of an antimony flame retardant compound;
(d) 0.03 to 0.8 percent by weight of sodium carbonate or potassium carbonate;
(e) 0 to 50 percent by weight of glass fiber; and

wherein requirements (i)-(iv) are met and the percent by weights are based on the total weight of the composition.

In another embodiment, the composition comprises:
(a) 49 to 58 percent by weight of PBT with an intrinsic viscosity of 0.66 cm³/g as measured in a 60:40 phenol/tetrachloroethane mixture;
(b) 9 to 12 percent by weight of TBBPA, poly(pentabromobenzylacrylate) or brominated polystyrene;
(c) 1.25 to 2.5 percent by weight of an antimony flame retardant compound;
(d) 0.03 to 0.8 percent by weight of sodium carbonate or potassium carbonate;
(e) 0 to 50 percent by weight of glass fiber; and

wherein requirements (i)-(iv) are met and the percent by weights are based on the total weight of the composition.

In another embodiment, the composition comprises:
(a) 52 to 58 percent by weight of PBT with an intrinsic viscosity of 0.66 cm³/g as measured in a 60:40 phenol/tetrachloroethane mixture;
(b) 9 to 12 percent by weight of TBBPA, of poly(pentabromobenzylacrylate) or brominated polystyrene;
(c) 1.25 to 2.5 percent by weight of Sb₂O₃;
(d) 0.03 to 0.8 percent by weight of sodium carbonate or potassium carbonate;
(e) 0 to 50 percent by weight of glass fiber; and

wherein requirements (i)-(iv) are met and the percent by weights are based on the total weight of the composition.

In the above embodiments and other embodiments of the method, the composition optionally further comprises a mold release agent. In a particular embodiment, the mold release agent is low density polyethylene (LDPE). In a further particular embodiment, the composition comprises 0.1 to 0.3 percent by weight of a mold release agent which is low density polyethylene (LDPE).

Thus, in another embodiment, the composition comprises:
(a) 49 to 52 percent by weight of PBT with an intrinsic viscosity of 0.66 cm³/g as measured in a 60:40 phenol/tetrachloroethane mixture and 6 percent by weight of PBT with an intrinsic viscosity of 1.2 cm3/g as measured in a 60:40 phenol/tetrachloroethane mixture;
(b) 9 to 12 percent by weight of TBBPA;
(c) 1.25 to 2.5 percent by weight of Sb₂O₃;
(d) 0.03 to 0.8 percent by weight of sodium carbonate or potassium carbonate;
(e) 0 to 50 percent by weight of glass fiber;
(f) 0.1 to 0.3 of a mold release agent; and

wherein requirements (i)-(iv) are met and the percent by weights are based on the total weight of the composition.

In another embodiment, the composition comprises:
(a) 52 to 58 percent by weight of PBT with an intrinsic viscosity of 0.66 cm³/g as measured in a 60:40 phenol/tetrachloroethane mixture;
(b) 9 to 12 percent by weight of poly(pentabromobenzylacrylate) or brominated polystyrene;
(c) 1.25 to 2.5 percent by weight of Sb₂O₃;
(d) 0.03 to 0.8 percent by weight of sodium carbonate or potassium carbonate;
(e) 0 to 50 percent by weight of glass fiber; and
(f) 0.1 to 0.3 percent by weight of a LDPE; and wherein
   (i) the composition meets or exceeds the requirements of UL94-V2;
   (ii) less antimony retardant compound is present in the composition comprising (a), (b), (c), and (d) as compared to a composition comprising component (a), (b), (c) and no (d);
   (iii) the comparative tracking index (CTI) for a composition comprising (a), (b), (c), and (d) is the same as or greater than the CTI of a composition comprising component (a), (b), (c) and no (d);
and wherein the percent by weights are based on the total weight of the composition.

In the above embodiments and other embodiments, the composition may optionally contain a filler. A preferred filler is talc. The talc may be coated, surface treated, or untreated. A variety of treated talcs are commercially available, for instance, from Mineral Technologies, Inc. In a particular embodiment, the composition contains 1 to 5 percent by weight of talc. In a more particular embodiment, the composition contains 1.5 to 3 percent by weight of talc.

Thus, in another embodiment, the composition comprises:
(a) 49 to 52 percent by weight of PBT with an intrinsic viscosity of 0.66 cm³/g as measured in a 60:40 phenol/tetrachloroethane mixture and 6 percent by weight of PBT with an intrinsic viscosity of 1.2 cm3/g as measured in a 60:40 phenol/tetrachloroethane mixture;
(b) 9 to 12 percent by weight of TBBPA or brominated polystyrene;
(c) 1.25 to 2.5 percent by weight of Sb₂O₃;
(d) 0.03 to 0.8 percent by weight of sodium carbonate or potassium carbonate;
(e) 0 to 50 percent by weight of glass fiber;
(f) 0.1 to 0.3 percent by weight of a LDPE;
(g) 1 to 5 percent by weight of talc; and

wherein requirements (i)-(iv) are met and the percent by weights are based on the total weight of the composition.

In another embodiment, the composition comprises:
(a) 52 to 58 percent by weight of PBT with an intrinsic viscosity of 0.66 cm³/g as measured in a 60:40 phenol/tetrachloroethane mixture;
(b) 9 to 12 percent by weight of poly(pentabromobenzylacrylate) or brominated polystyrene;
(c) 1.25 to 2.5 percent by weight of Sb₂O₃;
(d) 0.03 to 0.8 percent by weight of sodium carbonate or potassium carbonate;
(e) 0 to 50 percent by weight of glass fiber;
(f) 0 to 0.3 percent by weight of a LDPE;
(g) 1.5 to 3 percent by weight of talc; and

wherein requirements (i)-(iv) are met and the percent by weights are based on the total weight of the composition.

In the above embodiments, the glass fiber, when present, is borosilicate glass fiber (CAS Reg. No. 65997-17-3) not having a surface treatment, obtained from Chongqing Polycomp International Corp. When used in the composition, the glass fiber is normally included at a level of from about 1 to 50 percent by weight, more preferably from about 5 to 45 percent by weight, and more preferably 20 to about 40 percent by weight, and more preferably 25 to about 35 percent by weight based on the total weight of the composition.

Thus, in another embodiment, the composition comprises:
(a) 49 to 52 percent by weight of PBT with an intrinsic viscosity of 0.66 cm³/g as measured in a 60:40 phenol/tetrachloroethane mixture and 6 percent by weight of PBT with an intrinsic viscosity of 1.2 cm3/g as measured in a 60:40 phenol/tetrachloroethane mixture;
(b) 9 to 12 percent by weight of TBBPA or brominated polystyrene;
(c) 1.25 to 2.5 percent by weight of Sb₂O₃;
(d) 0.03 to 0.8 percent by weight of sodium carbonate or potassium carbonate;
(e) 20 to 40 percent by weight of glass fiber; and wherein:
(f) 0.1 to 0.3 percent by weight of a LDPE;
(g) 1 to 5 percent by weight of talc; and

wherein requirements (i)-(iv) are met and the percent by weights are based on the total weight of the composition.

In another embodiment, the composition comprises:
(a) 52 to 58 percent by weight of PBT with an intrinsic viscosity of 0.66 cm³/g as measured in a 60:40 phenol/tetrachloroethane mixture;
(b) 9 to 12 percent by weight of TBBPA, 9 to 12 percent by weight of TBBPA, of poly(pentabromobenzylacrylate) or brominated polystyrene;
(c) 1.25 to 2.5 percent by weight of Sb₂O₃;
(d) 0.03 to 0.8 percent by weight of sodium carbonate or potassium carbonate;
(e) 25 to 35 percent by weight of glass fiber; and wherein:
(f) 0 to 0.3 percent by weight of a LDPE;
(g) 1.5 to 3 percent by weight of talc; and

wherein requirements (i)-(iv) are met and the percent by weights are based on the total weight of the composition.

In another embodiment, the composition comprises:
(a) 52 to 58 percent by weight of PBT with an intrinsic viscosity of 0.66 cm³/g as measured in a 60:40 phenol/tetrachloroethane mixture;
(b) 9 to 12 percent by weight of poly(pentabromobenzylacrylate) or brominated polystyrene;
(c) 1.25 to 2.5 percent by weight of Sb₂O₃;
(d) 0.03 to 0.8 percent by weight of sodium carbonate or potassium carbonate;
(e) 25 to 35 percent by weight of glass fiber;
(f) 1.5 to 3 percent by weight of talc; and

wherein requirements (i)-(iv) are met and the percent by weights are based on the total weight of the composition.

In another aspect, the invention is directed to an article prepared from the any of the compositions disclosed herein.

### EMBODIMENTS

The invention includes the following embodiments:

### Embodiment 1

A method of reducing the amount of antimony flame retardant compound in a flame retardant composition which comprises using a combination of an alkali metal carbonate with a brominated flame retardant compound in the composition, wherein the composition comprises:
(a) 30 to 80 percent by weight of a polyester;
(b) 3 to 30 percent by weight of a brominated flame retardant compound;
(c) 0.1 to 5 percent by weight of an antimony flame retardant compound;
(d) 0.03 to 0.9 percent by weight of an alkali metal carbonate; and
(e) 0 to 50 percent glass fiber; and wherein:
   (i) the composition meets or exceeds the requirements of UL94-V2;
   (ii) less antimony retardant compound is present in the composition comprising (a), (b), (c), and (d) as compared to a composition comprising component (a), (b), (c) and no (d);
   (iii) the comparative tracking index (CTI) for a composition comprising (a), (b), (c), and (d) is the same as or greater than the CTI of a composition comprising component (a), (b), (c) and no (d);
   (iv) the composition does not contain a phosphorous containing flame retardant;
   and wherein the percent by weights are based on the total weight of the composition.

### Embodiment 2

The method of embodiment 1, wherein the polyester is a terephthalate-derived polyester selected from the group consisting of PET, PBT, PBT made from recycled PET, PCT, and PCTG, or a combination thereof.

### Embodiment 3

The method of embodiment 2, wherein the polyester is PET, PBT, or a combination thereof.

### Embodiment 4

The method of embodiment 2, wherein the polyester is PBT.

### Embodiment 5

The method of embodiment 2, wherein the composition comprises 52 to 58 percent by weight of PBT with an intrinsic viscosity of 0.66 cm³/g as measured in a 60:40 phenol/tetrachloroethane mixture; or a mixture comprising 49 to 52 percent by weight of PBT with an intrinsic viscosity of 0.66 cm³/g as measured in a 60:40 phenol/tetrachloroethane mixture and 4 to 8 percent by weight of PBT with an intrinsic viscosity of 1.2 cm3/g as measured in a 60:40 phenol/tetrachloroethane mixture.

### Embodiment 6

The method of embodiment 5, wherein the composition comprises:
(a) 52 to 58 percent by weight of PBT with an intrinsic viscosity of 0.66 cm³/g as measured in a 60:40 phenol/tetrachloroethane mixture; or a mixture comprising 49 to 52 percent by weight of PBT with an intrinsic viscosity of 0.66 cm³/g as measured in a 60:40 phenol/tetrachloroethane mixture and 6 percent by weight of PBT with an intrinsic viscosity of 1.2 cm3/g as measured in a 60:40 phenol/tetrachloroethane mixture;
(b) 9 to 12 percent by weight of TBBPA, poly(pentabromobenzylacrylate), or brominated polystyrene; and
(c) 0.03 to 0.8 percent by weight of sodium carbonate or potassium carbonate.

### Embodiment 7

The method of embodiment 6, wherein the composition comprises:
(b) 9 to 12 percent by weight of TBBPA, poly(pentabromobenzylacrylate), or brominated polystyrene;
(c) 1.25 to 2.5 percent by weight of Sb₂O₃; and
(d) 0.03 to 0.8 percent by weight of sodium carbonate or potassium carbonate.

### Embodiment 8

The method of embodiment 6, wherein the composition comprises:
(b) 9 to 12 percent by weight of TBBPA, poly(pentabromobenzylacrylate), or brominated polystyrene;
(c) 1.25 to 2.5 percent by weight of Sb₂O₃; and
(d) 0.03 to 0.8 percent by weight of sodium carbonate or potassium carbonate.

### Embodiment 9

The method of embodiment 6, wherein the composition comprises:
(b) 9 to 12 percent by weight of TBBPA, poly(pentabromobenzylacrylate), or brominated polystyrene;
(c) 1.25 to 2.5 percent by weight of Sb₂O₃; and
(d) 0.03 to 0.8 percent by weight of sodium carbonate or potassium carbonate.

### Embodiment 10

The method of embodiment 6, wherein the composition comprises:
(b) 9 to 12 percent by weight of TBBPA, poly(pentabromobenzylacrylate), or brominated polystyrene;
(c) 1.25 to 2.5 percent by weight of Sb₂O₃;
(d) 0.03 to 0.8 percent by weight of sodium carbonate or potassium carbonate;
(e) 0 to 50 percent glass fiber; and
(f) 0 to 0.3 percent by weight of a LDPE

### Embodiment 11

The method of embodiment 6, wherein the composition comprises:
(b) 9 to 12 percent by weight of TBBPA, poly(pentabromobenzylacrylate), or brominated polystyrene;
(c) 1.25 to 2.5 percent by weight of Sb₂O₃;
(d) 0.03 to 0.8 percent by weight of sodium carbonate or potassium carbonate; and
(e) 0 to 50 percent glass fiber;
(f) 0 to 0.3 percent by weight of a LDPE; and
(g) 1 to 5 percent by weight of talc.

### Embodiment 12

The method of embodiment 6, wherein the composition comprises:
(b) 9 to 12 percent by weight of TBBPA, poly(pentabromobenzylacrylate), or brominated polystyrene;
(c) 1.25 to 2.5 percent by weight of Sb₂O₃;
(d) 0.03 to 0.8 percent by weight of sodium carbonate or potassium carbonate;
(e) 20 to 40 percent glass fiber;
(f) 0 to 0.3 percent by weight of a LDPE; and
(g) 1 to 5 percent by weight of talc.

### Embodiment 13

The method of embodiment 6, wherein the composition comprises:
(b) 9 to 12 percent by weight of TBBPA, poly(pentabromobenzylacrylate), or brominated polystyrene;
(c) 1.6 to 2.2 percent by weight of Sb₂O₃;
(d) 0.08 to 0.24 percent by weight of sodium carbonate or potassium carbonate;
(e) 25 to 35 percent by weight glass fiber.
(f) 0.1 to 0.3 percent by weight of a LDPE; and
(g) 1.5 to 2.5 percent by weight of talc.

### Embodiment 14

The method of embodiment 6, wherein the composition comprises:
(a) 52 to 58 percent by weight of PBT with an intrinsic viscosity of 0.66 cm³/g as measured in a 60:40 phenol/tetrachloroethane mixture;
(b) 9 to 12 percent by weight of poly(pentabromobenzylacrylate) or brominated polystyrene;
(c) 1.25 to 2.5 percent by weight of Sb₂O₃;
(d) 0.03 to 0.8 percent by weight of sodium carbonate or potassium carbonate;
(e) 25 to 35 percent by weight glass fiber;
(f) 1.5 to 3 percent by weight of talc; and

wherein requirements (i)-(iv) are met and the percent by weights are based on the total weight of the composition.

### Embodiment 15

A flame retardant composition comprising:
(a) 30 to 80 percent by weight of a polyester;
(b) 3 to 30 percent by weight of a brominated flame retardant compound;
(c) 0.1 to 5 percent by weight of an antimony flame retardant compound;
(d) 0.03 to 0.9 percent by weight of an alkali metal carbonate;
(e) 0 to 50 percent by weight of glass fiber; and

wherein requirements (i)-(iv) are met and the percent by weights are based on the total weight of the composition.

### Embodiment 16

The composition of embodiment 15, wherein the polyester is a terephthalate derived polyester selected from the group consisting of PET, PBT, PBT made from recycled PET, PCT, and PCTG, or a combination thereof.

### Embodiment 17

The composition of embodiment 15, wherein the polyester is PBT.

### Embodiment 18

The composition of embodiment 15, wherein the composition comprises 52 to 58 percent by weight of PBT with an intrinsic viscosity of 0.66 cm³/g as measured in a 60:40 phenol/tetrachloroethane mixture; or a mixture comprising 49 to 52 percent by weight of PBT with an intrinsic viscosity of 0.66 cm³/g as measured in a 60:40 phenol/tetrachloroethane mixture and 6 percent by weight of PBT with an intrinsic viscosity of 1.2 cm3/g as measured in a 60:40 phenol/tetrachloroethane mixture.

### Embodiment 19

The composition of embodiment 18, wherein the composition comprises:
(a) 52 to 58 percent by weight of PBT with an intrinsic viscosity of 0.66 cm³/g as measured in a 60:40 phenol/tetrachloroethane mixture; or a mixture comprising 49 to 52 percent by weight of PBT with an intrinsic viscosity of 0.66 cm³/g as measured in a 60:40 phenol/tetrachloroethane mixture and 6 percent by weight of PBT with an intrinsic viscosity of 1.2 cm3/g as measured in a 60:40 phenol/tetrachloroethane mixture; and
(b) 9 to 12 percent by weight of TBBPA, poly(pentabromobenzylacrylate), or brominated polystyrene; and
(c) 0.03 to 0.8 percent by weight of sodium carbonate or potassium carbonate.

### Embodiment 20

The composition of embodiment 19, wherein the composition comprises:
(b) 9 to 12 percent by weight of TBBPA, poly(pentabromobenzylacrylate), or brominated polystyrene;
(c) 1.25 to 2.5 percent by weight of Sb₂O₃; and
(d) 0.03 to 0.8 percent by weight of sodium carbonate or potassium carbonate.

### Embodiment 21

The composition of embodiment 19, wherein the composition comprises:
(b) 9 to 12 percent by weight of TBBPA, poly(pentabromobenzylacrylate), or brominated polystyrene;
(c) 1.25 to 2.5 percent by weight of Sb₂O₃; and
(d) 0.03 to 0.8 percent by weight of sodium carbonate or potassium carbonate.

### Embodiment 22

The composition of embodiment 19, wherein the composition comprises:
(b) 9 to 12 percent by weight of TBBPA, poly(pentabromobenzylacrylate), or brominated polystyrene;
(c) 1.25 to 2.5 percent by weight of Sb₂O₃; and
(d) 0.03 to 0.8 percent by weight of sodium carbonate or potassium carbonate.

### Embodiment 23

The composition of embodiment 19, wherein the composition comprises:
(b) 9 to 12 percent by weight of TBBPA, poly(pentabromobenzylacrylate), or brominated polystyrene;
(c) 1.25 to 2.5 percent by weight of Sb₂O₃;
(d) 0.03 to 0.8 percent by weight of sodium carbonate or potassium carbonate; and
(f) 0 to 0.3 percent by weight of a LDPE

### Embodiment 24

The composition of embodiment 19, wherein the composition comprises:
(b) 9 to 12 percent by weight of TBBPA, poly(pentabromobenzylacrylate), or brominated polystyrene;
(c) 1.25 to 2.5 percent by weight of Sb₂O₃;
(d) 0.03 to 0.8 percent by weight of sodium carbonate or potassium carbonate; and
(f) 0 to 0.3 percent by weight of a LDPE; and
(g) 1 to 5 percent by weight of talc.

### Embodiment 25

The composition of embodiment 19, wherein the composition comprises:
(b) 9 to 12 percent by weight of TBBPA, poly(pentabromobenzylacrylate), or brominated polystyrene;
(c) 1.25 to 2.5 percent by weight of Sb₂O₃;
(d) 0.03 to 0.8 percent by weight of sodium carbonate or potassium carbonate;
(e) 20 to 40 percent by weight glass fiber;
(f) 0 to 0.3 percent by weight of a LDPE; and
(g) 1 to 5 percent by weight of talc.

### Embodiment 26

The composition of embodiment 19, wherein the composition comprises:
(b) 9 to 12 percent by weight of TBBPA, poly(pentabromobenzylacrylate), or brominated polystyrene;
(c) 1.6 to 2.2 percent by weight of Sb₂O₃;
(d) 0.08 to 0.24 percent by weight of sodium carbonate or potassium carbonate;
(e) 25 to 35 percent by weight glass fiber;
(f) 0.1 to 0.3 percent by weight of a LDPE; and
(g) 1.5 to 2.5 percent by weight of talc

### Embodiment 27

The composition of embodiment 19, wherein the composition comprises:
(a) 52 to 58 percent by weight of PBT with an intrinsic viscosity of 0.66 cm³/g as measured in a 60:40 phenol/tetrachloroethane mixture;
(b) 9 to 12 percent by weight of poly(pentabromobenzylacrylate) or brominated polystyrene;
(c) 1.25 to 2.5 percent by weight of Sb₂O₃;
(d) 0.03 to 0.8 percent by weight of sodium carbonate or potassium carbonate;
(e) 25 to 35 percent by weight glass fiber;

(f) 1.5 to 3 percent by weight of talc; and

wherein requirements (i)-(iv) are met and the percent by weights are based on the total weight of the composition.

### Embodiment 28

An article prepared by the method of embodiment 1 or from the composition of embodiment 14.

The following examples illustrate the scope of the invention. The examples and preparations which follow are provided to enable those skilled in the art to more clearly understand and to practice the present invention. They should not be considered as limiting the scope of the invention, but merely as being illustrative and representative thereof.

### EXAMPLES

The examples of the compositions of the present invention, annotated hereinafter as “EX.” and their comparative examples, annotated hereinafter as “CEX”, employed the materials listed in Table 1. All percent by weights employed in the examples are based on the percent by weight of the entire composition except where stated otherwise.

TABLE 1

| Component | Trade Name and Supplier |
|---|---|
| Polyester I | Polybutylene Terephthalate (PBT) sold by SABIC |
| | Innovative Plastics as VALOX ® 315 with an intrinsic |
| | viscosity of 1.2 cm³/g as measured in a 60:40 |
| | phenol/tetrachloroethane. |
| Polyester II | Polybutylene Terephthalate (PBT), sold by SABIC |
| | Innovative Plastics as VALOX ® 195 with an intrinsic |
| | viscosity of 0.66 cm³/g as measured in a 60:40 |
| | phenol/tetrachloroethane. |
| Phenoxy-terminated | BC-52, CAS Reg. No. 71342-77-3, obtained from ICL |
| Tetrabrombisphenol A carbonate | Industrial Products. |
| oligomer (TBBPA) | |
| Poly(pentabromobenzylacrylate) | Br-Acrylate, CAS Reg. No. 59447-57-3, obtained |
| | from ICL Industrial Products. |
| Brominated Polystyrene | Br-PS, CAS Reg. No. 88497-56-7, from Albemarle |
| | Corporation. |
| Polytetrafluoroethylene | PTFE, CAS Reg. No. 9002-84-0, obtained from |
| | SABIC Innovative Plastics. |
| Stabilizer | Pentaerythritol tetrakis(3,5-di-tert-butyl-4- |
| | hydroxyhydrocinnamate), CAS Reg. No. 6683-19-8, |
| | from BASF. |
| Mold Release Agent | Low density polyethylene (LDPE), CAS Reg. No. |
| | 9002-88-4, from SABIC Innovative Plastics. |
| Glass Fiber | CAS Reg. No. 65997-17-3, from Chongqing Polycomp |
| | International Corp. as ECS303A. |
| Antimony Oxide | Sb₂O₃ CAS Reg. No. 1309-94-4; obtained from |
| | Campine N.V. (Belgium) as Antiox PBT 262415. |
| Talc | JETFINE ® 3CA obtained from LUZENAC EUROPE |
| | SAS. |

### Testing

The tests used to characterize the compositions of the present invention, and the comparative examples, are summarized below in Table 2.

TABLE 2
Tests

| | Standards | Testing Conditions |
|---|---|---|
| Melt Volume Rate (MVR) | ASTM D 1238 | 250° C., 5 Kg |
| Uniaxial Tensile test | ASTM D 638 | 5 mm/min |
| Notched Izod Impact (NII) | ASTM D 256 | 5 lbf, 23° C., 3.2 mm |
| Vicat softening temperature (VIC) | ASTM D 1525 | 50 N, 120° C. /h |

Flammability testing was conducted according to UL 94 regulations. The total flame-out-time was calculated at a specified thickness (0.75 mm). Table 3 shows the criteria for V0, V1, and V2 under UL94 standards. For a sample that meets V-2, burning stops within 30 seconds on a vertical specimen; drips of flaming particles are allowed. For a sample that meets V1, burning stops within 30 seconds on a vertical specimen; drips of particles allowed as long as they are not inflamed. For samples that meet V-0, burning stops within 10 seconds on a vertical specimen; drips of particles allowed as long as they are not inflamed.

TABLE 3
Material FR VX classifications under the UL94 protocol.

| Criteria conditions | V-0 | V-1 | V-2 |
|---|---|---|---|
| After flame time for each individual | ≦10 s | ≦30 s | ≦30 s |
| specimen t1 or t2 | | | |
| Total after flame time for any condition set | ≦50 s | ≦250 s | ≦250 s |
| (t1 plus t2 for the 5 specimen) | | | |
| After flame plus afterglow time for each | ≦30 s | ≦60 s | ≦60 s |
| individual specimen after the second | | | |
| flame application (t2 + t3) | | | |
| After flame or afterglow of any specimen up | No | No | No |
| to the holding clamp | | | |
| Cotton indicator ignited by flaming particles | No | No | No |
| or drops | | | |

### Compounding and Molding

Typical compounding and molding procedures are described as follows.

All the ingredients except glass fiber were pre-blended, and then extruded using a twin extruder. A typical extruding condition is listed in Table 4.

TABLE 4
Compounding condition for FR polycarbonate resins.

| Parameters | | |
|---|---|---|
| Die | mm | 4 |
| Zone 1 Temp | ° C. | 100 |
| Zone 2 Temp | ° C. | 200 |
| Zone 3 Temp | ° C. | 240 |
| Zone 4 Temp | ° C. | 240 |
| Zone 5 Temp | ° C. | 240 |
| Zone 6 Temp | ° C. | 240 |
| Zone 7 Temp | ° C. | 250 |
| Zone 8 Temp | ° C. | 250 |
| Zone 9 Temp | ° C. | 260 |
| Die Temp | ° C. | 265 |
| Screw speed | rpm | 200 |
| Throughput | kg/hr | 60 |

The extruded pellets were molded in different shapes for mechanical tests. Table 5 shows a typical molding condition.

TABLE 5
Molding condition for FR PBT resins.

| Parameters | | |
|---|---|---|
| Cnd: Pre-drying time | Hour | 4 |
| Cnd: Pre-drying temp | ° C. | 120 |
| Hopper temp | ° C. | 50 |
| Zone 1 temp | ° C. | 250 |
| Zone 2 temp | ° C. | 250 |
| Zone 3 temp | ° C. | 250 |
| Nozzle temp | ° C. | 250 |
| Mold temp | ° C. | 50 |
| Screw speed | rpm | 100 |
| Back pressure | kgf/cm² | 50 |
| Molding Machine | NONE | Faunc |
| Mold Type (insert) | NONE | ASTM |

### Results

A range of PBT compositions was evaluated. In Table 6, phenoxy-terminated tetrabromobisphenol-A carbonate oligomer (BC-52) was used as the brominated flame retardant. Varying amounts of the alkali metal carbonates sodium carbonate or potassium carbonate were used.

TABLE 6

| | CEX1 | EX1 | EX2 | EX3 | EX4 | CEX2 | EX5 | CEX3 |
|---|---|---|---|---|---|---|---|---|
| Polyester I | 6.00 | 6.00 | 6.00 | 6.00 | 6.00 | 6.00 | 6.00 | 6.00 |
| Polyester II | 49.94 | 51.49 | 51.39 | 51.19 | 49.89 | 50.59 | 51.49 | 50.59 |
| BC-52 | 10.5 | 10.5 | 10.5 | 10.5 | 10.5 | 10.5 | 10.5 | 10.5 |
| Stabilizer | 0.06 | 0.06 | 0.06 | 0.06 | 0.06 | 0.06 | 0.06 | 0.06 |
| Mold release agent | 0.2 | 0.2 | 0.2 | 0.2 | 0.2 | 0.2 | 0.2 | 0.2 |
| Glass fiber | 30 | 30 | 30 | 30 | 30 | 30 | 30 | 30 |
| Sb₂O₃ | 3.3 | 1.65 | 1.65 | 1.65 | 1.65 | 1.65 | 1.65 | 1.65 |
| Na₂CO₃ | 0 | 0.1 | 0.2 | 0.4 | 0.7 | 1.0 | 0 | 0 |
| K₂CO₃ | 0 | 0 | 0 | 0 | 0 | 0 | 0.1 | 1.0 |
| MVR-ASTM | 34 | 36 | 40 | 44 | 54 | 58 | 42 | 82 |
| (cm³/10 min) | | | | | | | | |
| Tens-M (GPa) | 10.2 | 10.1 | 10.5 | 10.2 | 10.2 | 10.6 | 10.4 | 10.9 |
| Tens-S (MPa) | 118 | 125 | 130 | 117 | 116 | 110 | 132 | 117 |
| Tens-E (%) | 2.1 | 2.2 | 2.2 | 2.0 | 1.9 | 1.9 | 2.3 | 1.8 |
| VIC (120° C./h, 50N) | 203 | 198 | 193 | 192 | 193 | 193 | 195 | 193 |
| Izod-N (J/m) | 65 | 64 | 85 | 77 | 63 | 65 | 76 | 73 |
| CTI (V) | 175 | 175 | 175 | 175 | 175 | 175 | 175 | 175 |
| FR 0.75 mm (UL) | V0/V2 | V0 | V0 | V0/V2 | V0/V2 | V2 | V0 | V2 |

In Comparative Example 1 (CEX1, “Control”), no sodium carbonate or potassium carbonate was present in the composition. In EX1-4 and EX5, varying amounts of sodium carbonate (EX1-4) or potassium carbonate (EX5) were present in the composition and the amount of antimony oxide was reduced from 3.3 percent by weight to 1.65 percent by weight (50 percent less Sb₂O₃). CEX2 and CEX3 show that when 1 percent by weight of sodium or potassium carbonate is present, flame retardance worsens (V2) compared to CE1 (V0N2). Mechanical properties were comparable in EX1-4 and EX5 as compared CEX1. CTI remained the same as compared to CEX1. Flame retardance was comparable (EX3 and EX4) or improved (EX1, EX2, EX5).

Table 7 summarizes the results for compositions containing alkali metal carbonate as well as talc. CEX4 was free of both sodium carbonate and talc and contained 4 percent by weight of antimony trioxide. EX6 and EX7 contained half the amount of antimony trioxide as CEX4 and 0.05 percent by weight of sodium carbonate and 1.95 percent by weight of talc (EX6), or 0.1 percent by weight of sodium carbonate and 1.9 percent by weight of talc (EX7), respectively. Mechanical properties were comparable in EX6-7 as compared to CEX4. CTI remained the same as compared to CEX4, while flame retardance was improved. Table 7 also indicates that that after up to a 50 percent reduction of Sb₂O₃ by increasing Na₂CO₃/talc loading, flame retardance improved while the other performance characteristics were maintained (EX6-9). When the percent by weightage of Na₂CO₃ was approximately 0.1-0.2% and the percent by weight of talc was approximately 1.8-1.95% (EX7-11), robust V0@0.75 mm was achieved.

TABLE 7

| | CEX4 | EX6 | EX7 | EX8 | EX9 | EX10 | EX11 |
|---|---|---|---|---|---|---|---|
| Polyester II | 56 | 56 | 56 | 56 | 56 | 53 | 55 |
| Br-acrylate | 10 | 10 | 10 | | | | 8 |
| Br-PS | | | | 10 | 10 | 10 | |
| Glass fiber | 30 | 30 | 30 | 30 | 30 | 30 | 30 |
| Sb₂O₃ | 4 | 2 | 2 | 2 | 2 | 2.5 | 2.5 |
| Na₂CO₃ | 0 | 0.05 | 0.1 | 0.1 | 0.2 | 0.1 | 0.1 |
| talc | 0 | 1.95 | 1.9 | 1.9 | 1.8 | 2 | 2 |
| MVR-ASTM | 31 | 32 | 28 | 26 | 22 | — | — |
| (cm³/10 min) | | | | | | | |
| Tens-M (GPa) | 10.8 | 11.0 | 11.2 | 10.9 | 11.0 | — | — |
| Tens-S (MPa) | 135 | 133 | 135 | 131 | 132 | — | — |
| Tens-E (%) | 2.5 | 2.5 | 2.5 | 2.3 | 2.3 | — | — |
| VIC (120° C./h, | 209 | 208 | 208 | 210 | 210 | — | — |
| 50N) | | | | | | | |
| Izod-N (J/m) | 78 | 77 | 75 | 72 | 73 | — | — |
| CTI (V) | 250 | 250 | 250 | 300 | 300 | — | — |
| FR 0.75 mm (UL) | V2 | V0/V2 | V0 | V0 | V0 | V0 | V0 |

The foregoing invention has been described in some detail by way of illustration and example for purposes of clarity and understanding. The invention has been described with reference to various specific embodiments and techniques. It should be understood that many variations and modifications may be made while remaining within the spirit and scope of the invention. It will be obvious to one of skill in the art that changes and modifications may be practiced within the scope of the appended claims. The above description is intended to be illustrative and not restrictive. The scope of the invention should, therefore, be determined not with reference to the above description, but should instead be determined with reference to the following appended claims, along with the full scope of equivalents to which such claims are entitled.

1. A method of reducing the amount of antimony flame retardant compound in a flame retardant composition which comprises combining an alkali metal carbonate with a brominated flame retardant compound in preparing the composition, wherein the composition comprises:
(a) 40 to 70 percent by weight of polyethylene terephthalate (PET), polybutylene terephthalate (PBT), PBT made from recycled PET, PCT, and glycol modified polycyclohexylenedimethylene terephthalate (PCTG), or a combination thereof;
(b) 3 to 30 percent by weight of a brominated flame retardant compound;
(c) 0.5 to 4.5 percent by weight of Sb₂O₃;
(d) 0.03 to 0.9 percent by weight of sodium carbonate or potassium carbonate; and
(e) 5 to 45 percent by weight of glass fiber; and wherein:
(i) the composition meets or exceeds the requirements of UL94-V2;
(ii) less antimony retardant compound is present in the composition comprising (a), (b), (c), and (d) as compared to a composition comprising component (a), (b), (c) and no (d);
(iii) the comparative tracking index (CTI) for a composition comprising (a), (b), (c), and (d) is the same as or greater than the CTI of a composition comprising component (a), (b), (c) and no (d);
(iv) the composition does not contain a phosphorous containing flame retardant;
and wherein the percent by weights are based on the total weight of the composition.

2. (canceled)

3. The method of claim 1, wherein the polyester is PET, PBT, or a combination thereof.

4. The method of claim 1, wherein the polyester is PBT.

5. The method of claim 1, wherein the composition comprises 52 to 58 percent by weight of PBT with an intrinsic viscosity of 0.66 cm³/g as measured in a 60:40 phenol/tetrachloroethane mixture; or a mixture comprising 49 to 52 percent by weight of PBT with an intrinsic viscosity of 0.66 cm³/g as measured in a 60:40 phenol/tetrachloroethane mixture and 4 to 8 percent by weight of PBT with an intrinsic viscosity of 1.2 cm3/g as measured in a 60:40 phenol/tetrachloroethane mixture.

6. The method of claim 5, wherein the composition comprises:
(a) 52 to 58 percent by weight of PBT with an intrinsic viscosity of 0.66 cm³/g as measured in a 60:40 phenol/tetrachloroethane mixture; or a mixture comprising 49 to 52 percent by weight of PBT with an intrinsic viscosity of 0.66 cm³/g as measured in a 60:40 phenol/tetrachloroethane mixture and 6 percent by weight of PBT with an intrinsic viscosity of 1.2 cm3/g as measured in a 60:40 phenol/tetrachloroethane mixture;
(b) 9 to 12 percent by weight of TBBPA, poly(pentabromobenzylacrylate), or brominated polystyrene; and
(d) 0.03 to 0.8 percent by weight of sodium carbonate or potassium carbonate.

7. The method of claim 6, wherein the composition comprises:
(b) 9 to 12 percent by weight of TBBPA, poly(pentabromobenzylacrylate), or brominated polystyrene;
(c) 1.25 to 2.5 percent by weight of Sb₂O₃; and
(d) 0.03 to 0.8 percent by weight of sodium carbonate or potassium carbonate.

8. The method of claim 6, wherein the composition comprises:
(b) 9 to 12 percent by weight of phenoxy-terminated tetrabrombisphenol A carbonate oligomer, poly(pentabromobenzylacrylate), or brominated polystyrene;
(c) 1.25 to 2.5 percent by weight of Sb₂O₃; and
(d) 0.03 to 0.8 percent by weight of sodium carbonate or potassium carbonate.

9. (canceled)

10. The method of claim 6, wherein the composition comprises:
(b) 9 to 12 percent by weight of phenoxy-terminated tetrabrombisphenol A carbonate oligomer, poly(pentabromobenzylacrylate), or brominated polystyrene;
(c) 1.25 to 2.5 percent by weight of Sb₂O₃;
(d) 0.03 to 0.8 percent by weight of sodium carbonate or potassium carbonate;
(e) 0 to 50 percent glass fiber; and
(f) 0.1 to 0.3-percent by weight of a LDPE.

11. The method of claim 6, wherein the composition comprises:
(b) 9 to 12 percent by weight of TBBPA, poly(pentabromobenzylacrylate), or brominated polystyrene;
(c) 1.25 to 2.5 percent by weight of Sb₂O₃;
(d) 0.03 to 0.8 percent by weight of sodium carbonate or potassium carbonate; and
(e) 5 to 45 percent by weight of glass fiber;
(f) 0 to 0.3 percent by weight of a LDPE; and
(g) 1 to 5 percent by weight of talc.

12. The method of claim 6, wherein the composition comprises:
(b) 9 to 12 percent by weight of TBBPA, poly(pentabromobenzylacrylate), or brominated polystyrene;
(c) 1.25 to 2.5 percent by weight of Sb₂O₃;
(d) 0.03 to 0.8 percent by weight of sodium carbonate or potassium carbonate;
(e) 20 to 40 percent glass fiber;
(f) 0 to 0.3 percent by weight of a LDPE; and
(g) 1 to 5 percent by weight of talc.

13. The method of claim 6, wherein the composition comprises:
(b) 9 to 12 percent by weight of TBBPA, poly(pentabromobenzylacrylate), or brominated polystyrene;
(c) 1.6 to 2.2 percent by weight of Sb₂O₃;
(d) 0.08 to 0.24 percent by weight of sodium carbonate or potassium carbonate;
(e) 25 to 35 percent by weight glass fiber; and further comprising
(f) 0.1 to 0.3 percent by weight of a LDPE; and
(g) 1.5 to 2.5 percent by weight of talc.

14. The method of claim 6, wherein the composition comprises:
(a) 52 to 58 percent by weight of PBT with an intrinsic viscosity of 0.66 cm³/g as measured in a 60:40 phenol/tetrachloroethane mixture;
(b) 9 to 12 percent by weight of poly(pentabromobenzylacrylate) or brominated polystyrene;
(c) 1.25 to 2.5 percent by weight of Sb₂O₃;
(d) 0.03 to 0.8 percent by weight of sodium carbonate or potassium carbonate;
(e) 25 to 35 percent by weight glass fiber; and
(f) 1.5 to 3 percent by weight of talc.

15-27. (canceled)

28. An article prepared from the composition of claim 1, wherein the article is a covering for an electrical wire or electrical component.
